(19) United States
(12) Patent Application Publication
(10) Pub. No.: US 2017/0234226 A1
(43) Pub. Date: Aug. 17, 2017

(54) Cooled Combustor Case with Over-Pressurized Cooling Air

(71) Applicant: Russell B. Jones, North Palm Beach, FL (US)

(72) Inventor: Russell B. Jones, North Palm Beach, FL (US)

(21) Appl. No.: 15/340,532

(22) Filed: Nov. 1, 2016

Related U.S. Application Data
(60) Provisional application No. 62/295,811, filed on Feb. 16, 2016.

(51) Int. Cl. F02C 7/18; F23R 3/00; F23R 3/02

(52) U.S. Cl. CPC F02C 7/18; F23R 3/02; F23R 3/002

(57) ABSTRACT

A combustor of an industrial gas turbine engine having a combustor secured within a combustor casing with a combustor cavity surrounding the combustor, and a flow liner forming a cooling air space between the casing and the flow liner in which high pressure cooling air can be passed to provide insulation to the casing from the high temperature gas surround the combustor. The flow liner can include a TBC or a layer of insulation to limit heat buildup of the cooling air flowing through the space to further insulate the casing.

### CROSS-REFERENCE TO RELATED APPLICATIONS

This application claims the benefit to U.S. Provisional Application 62/295,811 filed Feb. 16, 2016 and entitled COOLED COMBUSTOR CASE WITH OVER-PRESSURIZED COOLING AIR.

### GOVERNMENT LICENSE RIGHTS

This invention was made with Government support under contract number DE-FE0023975 awarded by Department of Energy. The Government has certain rights in the invention.

### BACKGROUND OF THE INVENTION

Field of the Invention

The present invention relates generally to an industrial gas turbine engine, and more specifically an industrial gas turbine engine with a combustor flow liner to maintain a relatively low metal temperature of a combustor casing.

Description of the Related Art including information disclosed under 37 CFR 1.97 and 1.98

In an industrial gas turbine engine, compressed air from a compressor is delivered to a combustor cavity surrounding a combustor, where the compressed air flows into the combustor and is burned with a fuel to produce a hot gas flow that is then passed through a turbine to drive the compressor and an electric generator. The compressed air surrounding the combustor is also in contact with a combustor casing of the engine that is formed of a relatively thick metal material. The combustor casing must be made relatively thick in order to withstand the high pressure of the compressor exit air that surrounds the combustor and eventually flows into the combustor. The high temperature exposed to the combustor casing will limit the life of the casing and thus limit the life of the engine.

### BRIEF SUMMARY OF THE INVENTION

An industrial gas turbine engine has a compressor that delivers high pressure air to a combustor cavity that surrounds a combustor and then flows into the combustor to be burned with a fuel to produce a hot gas flow. A turbine part such as a row of turbine stator vanes includes a cooling circuit in which compressed air is passed through for cooling of the turbine part, and the spent cooling air is delivered to the combustor through the combustor cavity instead of being discharged into the hot gas flow passing through the turbine. The cooling air for the turbine part is pressurized over the compressor discharge pressure so that the cooling air can cool the part and still have enough pressure for discharge into the combustor. The combustor casing part cooling air is cooled using an intercooler, and then the cooled highly pressurized air is passed through a flow liner passage to provide for an insulation to an inner side of the combustor casing to prevent over-heating of the casing. The cooling air used to cool the casing is then discharged into the combustor cavity along with the compressor discharge, and then flows into the combustor.

The flow liner can be an annular single sheet liner to channel cooling air along the space within the casing, or the liner can be formed as a series of cooling channels each with an inlet and a discharge to discharge the cooling air into the combustor cavity.

The flow liner can be coated on an outer side with a thermal barrier coating to limit heat transfer from the hot flow liner into the cooling air passing underneath the casing.

### BRIEF DESCRIPTION OF THE SEVERAL VIEWS OF THE DRAWINGS

FIG. 1 shows a cross section view of a combustor case of an industrial gas turbine engine of the present invention.

FIG. 2 shows a cross section view of a combustor case of an industrial gas turbine engine according to a second embodiment of the present invention.

FIG. 3 shows a cross section close-up view of a combustor casing and flow liner of an industrial gas turbine engine according to a third embodiment of the present invention.

FIG. 4 shows a cross section view of a section of a flow liner used in the combustor of the present invention.

FIG. 5 shows a cross section view of a section of the flow liner with a thermal barrier coating on the cooling air flow side of the present invention.

FIG. 6 shows a cross section view of a section of the flow liner with an insulator between two walls of the present invention.

### DETAILED DESCRIPTION OF THE INVENTION

The present invention is cooled combustor casing of an industrial gas turbine engine in which cooling air pressurized over the compressor exit pressure (referred to as P3) is cooled through a heat exchanger and then used to cool the combustor case so that the heated cooling air can be introduced into the combustor to burn with a fuel. This allows for lower temperature resistant and cheaper metal materials to be used for the combustor casing which must be relatively thick to withstand the high pressure at higher temperature within the combustor cavity. In the industrial gas turbine engine of the present invention, compressed air is supplied to an air cooled turbine part such as a row of stator vanes to provide cooling. The spent cooling air from the cooled turbine part is then discharged into the combustor to be burned with fuel instead of being discharged out into the turbine hot gas flow through film holes in the turbine part. This spent cooling air must be slightly higher in pressure than the compressor outlet pressure (P3) so that the spent cooling air can be discharged into the combustor to merge with the compressed air from the compressor exit at P3 pressure. The compressed air used for cooling of the turbine part can be compressed upstream of the turbine part with enough pressure to flow into the combustor, or the spent cooling air from the turbine part can be further compressed in a fan downstream of the turbine part and upstream of the combustor, and in both examples the compressed air to be used for cooling can be cooled using an intercooler before or after the boost compression occurs. It is this cooled over-pressurized cooling air supply that is passed through the space formed between the combustor casing and the flow liner that eventually flows back into the combustor cavity and then into the combustor combustion chamber.

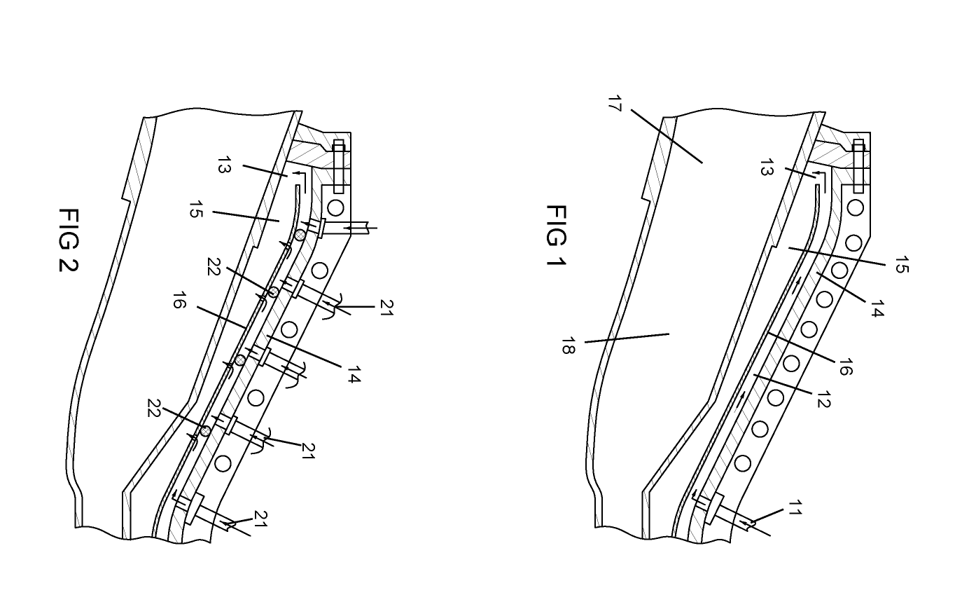

To utilize a low cost steel material for the combustor casing such as a steel or steel alloy, this invention proposes the use of a pre-conditioned high pressure, low-temperature cooling air supply from a semi-closed loop Advanced Recirculating Total Impingement Cooling return system. Cooling air fed into the combustor case is pressurized over the compressor exit pressure (P3) and cooled through a heat exchanger to pre-condition the cooling air flow. The use of pre-conditioned over pressurized air (>P3) presents an innovative solution for the state-of-the-art systems which contain low available pressure ratios in combustor case cooling. The present invention, as shown in FIGS. 1 and 2, supplies the pre-conditioned cooling air via a plurality of pipes at the static outer casing. The combustor casing 14 must be relatively thick in order to withstand the relatively high pressure of the compressor discharge surrounding the combustor. The flow liner 16 is exposed to even pressure over both sides and thus can be as thin as required. However, the flow liner should be made from a material with low oxidation characteristics such as nickel based alloys but could also be made of the same material as the casing 14. Cooling of the casing 14 is desirable to around 950 degrees F. in order to maximize the life of the thick casing.

FIG. 1 shows a first embodiment of the combustor casing cooling design in which preconditioned air is supplied at supply flange 11 with convective cooling through one annular channel or a plurality of circumferential cooling channels 12 flowing from the aft of the case forward. The channel(s) purge spent cooling flow into the combustor cavity 13. A annular shaped combustor flow liner 16 made from a high temperature resistant material is used to protect the combustor casing 14 which is made of a lower cost and lower temperature resistant metal. A hot air channel 15 surrounding the combustor 17 and transition duct 18 would be too hot for the combustor casing 14 to handle without cooling and thus would shorten the life of the combustor casing 14. The preconditioned cooling air introduced through the supply flange or pipe 11 would flow is a space formed between the flow liner 16 and the combustor casing 14 to provide insulation to the casing 14 from the hot gas surrounding the combustor 15. Since the flow liner can be made from a thinner piece of metal than the casing 14, the flow liner can be made from a more expensive and higher heat resistant metal. Compressed air from the compressor flows into the cavity 15 surrounding the combustor 17 and the transition duct 18 and thus is relatively hot such that if the casing was exposed directly to the hot compressor gas its life would be limited.

FIG. 2 shows a second embodiment of the combustor casing cooling design which includes convective cooling through a series of axial spaced impingement and circumferential cooling channel segments. Pre-conditioned cooling air can also be fed through a plurality of pipes 21 at the static outer casing 14 at multiple locations as shown in FIG. 2 to minimize the cooling air heat up through the length of the casing cooling circuit. The cooling air discharged is then returned into the combustor casing for where it can be mixed with fuel to be burned in the combustor. Each of the preconditioned cooling air supply pipes 21 delivers the cooling air to a space formed between the combustor casing 14 and the flow liner 16. In the FIG. 2 embodiment, a high temperature resistant annular seal 22 is used to separate adjacent spaces so that the cooling air will be discharged through holes in the flow liner 16 and into the space surrounding the combustor 15. The benefit to the FIG. 2 embodiment over the FIG. 1 embodiment is that fresh cooling air is used for each of the separate cooling flow spaces formed between the liner 16 and the casing 14. In the FIG. 1 embodiment, the cooling air will be quite hot when it reaches the end in which all of the cooling air flows into the combustor cavity 13. The FIG. 2 embodiment requires more cooling air, but results in a more uniform temperature distribution of the combustor casing 14.

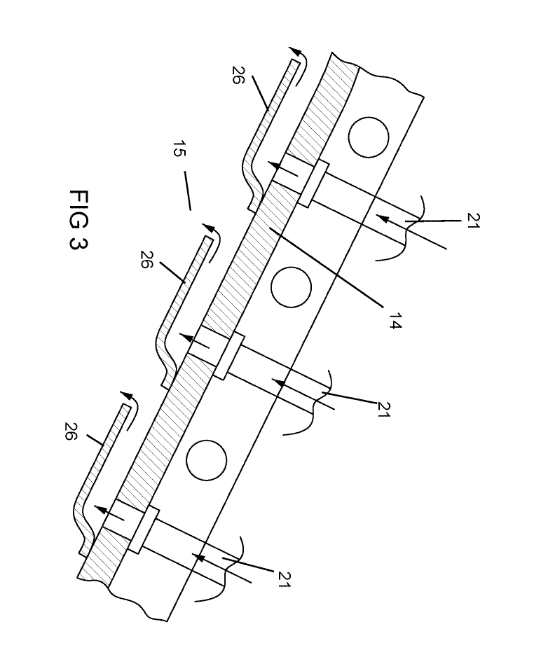

FIG. 3 shows a third embodiment of the combustor cooling design in which the one piece annular flow liner with seals of FIG. 2 is replaced with individual annular flow liners 26 arranged in series with the casing 14. Each individual flow liner 26 is secured to the underside of the casing 14 to form a separate annular shaped cooling air passage between the flow liner 26 and the casing 14. The cooling air flow out the forward end of the space and into the combustor cavity 13.

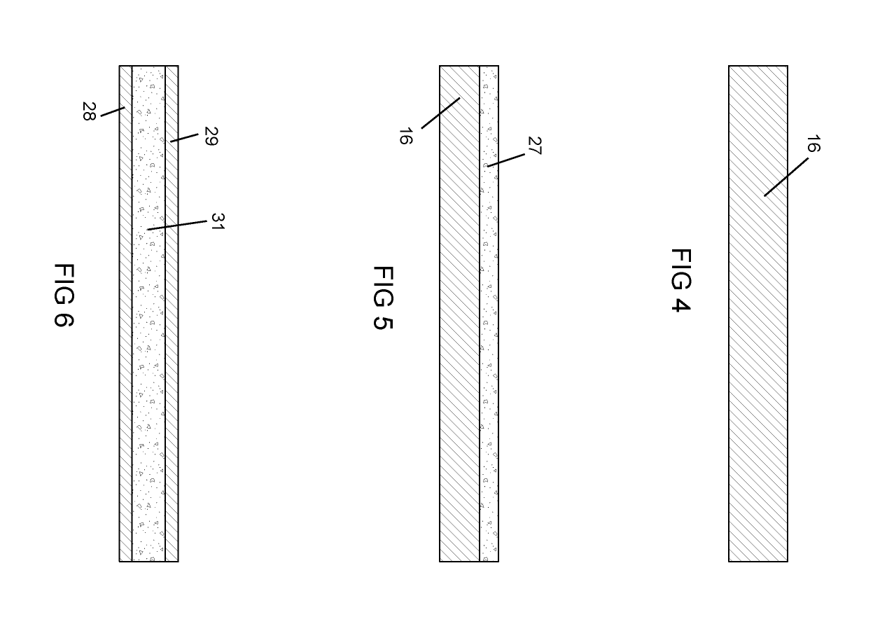

FIGS. 4-6 show different embodiment of the flow liner used in the present invention. In FIG. 4, the flow liner 16 is a plain metal liner made from a high temperature resistant material that can withstand the high temperature of the gas surrounding the combustor in the cavity 13. FIG. 5 shows a TBC 27 on the outer surface of the flow liner exposed to the cooling air flow in the space formed between the flow liner and the casing 14. The TBC 27 prevents the cooling air from heating up too much so that the casing 14 remains relatively cool. FIG. 6 shows a flow liner made from two walls 28 and 29 with an insulator 31 formed between the two walls.

I claim the following:

1. A combustor for a gas turbine engine comprising:
a combustor for burning a fuel with compressed air to produce a hot gas flow;
a transition duct downstream of the combustor to channel the hot gas flow from the combustor;
a combustor casing to surrounding the combustor and the transition duct;
a flow liner forming a cooling air space between the combustor casing, the transition duct, and the flow liner;
a cooling air inlet in the combustor casing to supply cooling air to the space between the flow liner and the combustor casing;
a cooling air discharge on the flow liner to discharge the cooling air into a combustor cavity; and,
the cooling air flowing in the space insulates the combustor casing from a hot gas surrounding the combustor.

2. The combustor of claim 1, and further comprising:
the flow liner is an annular flow liner that forms one space for cooling air to flow from an aft side to a forward side of the flow liner.

3. The combustor of claim 1, and further comprising:
the flow liner is an annular flow liner that forms multiple spaces for cooling air to flow from an aft side to a forward side of the flow liner with each space separated by an annular seal.

4. The combustor of claim 1, and further comprising:
the flow liner is formed as a series of annular flow liners each with a cooling air inlet into the space and a discharge out from the space and into the combustor cavity.

5. The combustor of claim 1, and further comprising:
the flow liner is an annular flow liner with a single wall.

6. The combustor of claim 1, and further comprising:
the flow liner is an annular flow liner with a single wall having a thermal barrier coating on a side on which the cooling air flows.

7. The combustor of claim 1, and further comprising:
the flow liner is an annular flow liner with an insulator formed between an inner annular wall and an outer annular wall.

8. The combustor of claim 1, and further comprising:
the cooling air flows through the space formed between the casing and the flow liner in a forward direction of the combustor hot gas flow.
